(19) United States
(12) Patent Application Publication
(10) Pub. No.: US 2006/0156989 A1
(43) Pub. Date: Jul. 20, 2006

(54) Methods and apparatus for detecting the presence of eggs in an egg flat

(75) Inventor: John H. Hebrank, Durham, NC (US)

Correspondence Address: MYERS BIGEL SIBLEY & SAJOVEC, PO BOX 37428, RALEIGH, NC, 27627, US

(73) Assignee: Embrex, Inc.

(21) Appl. No.: 11/329,213

(22) Filed: Jan. 10, 2006

Related U.S. Application Data
(60) Provisional application No. 60/644,859, filed on Jan. 18, 2005.

(51) Int. Cl. A01K 45/00

(52) U.S. Cl. 119/6.8

(57) ABSTRACT

Methods and apparatus for accurately and reliably detecting the presence of eggs within pockets of an egg flat are provided. An in ovo injection apparatus includes a plurality of injection devices configured to inject substances into a respective plurality of eggs held within respective pockets of an egg flat, and a sensor associated with each pocket of the egg flat that detects the presence of an egg therewithin. Each sensor communicates whether an egg is present or not within a respective pocket to a respective injection device. Each sensor may be configured to detect injection tool position, wherein injection tool position indicates whether an egg is present or not within a respective pocket.

### RELATED APPLICATION

This application claims the benefit of and priority to U.S. Provisional Patent Application No. 60/644,859 filed Jan. 18, 2005, the disclosure of which is incorporated herein by reference as if set forth in its entirety.

### FIELD OF THE INVENTION

The present invention relates generally to eggs and, more particularly, to methods and apparatus for processing eggs.

### BACKGROUND OF THE INVENTION

Discrimination between poultry eggs on the basis of some observable quality is a well-known and long-used practice in the poultry industry. “Candling” is a common name for one such technique, a term which has its roots in the original practice of inspecting an egg using the light from a candle. As is known to those familiar with eggs, although egg shells appear opaque under most lighting conditions, they are in reality somewhat translucent, and when placed in front of a direct light, the contents of the egg can be observed.

An egg may be a “live” egg, meaning that it has a viable embryo. An egg may be a “clear” or “infertile” egg, meaning that it does not have a viable embryo. More particularly, a “clear” egg is an infertile egg that has not rotted. An egg may be an “early dead” egg, meaning that it has an embryo which died at about one to five days old. An egg may be a “mid-dead” egg, meaning that it has an embryo which died at about five to fifteen days old. An egg may be a “late-dead” egg, meaning that it has an embryo which died at about fifteen to eighteen days old.

An egg may be a “rotted” egg, meaning that the egg includes a rotted infertile yolk (for example, as a result of a crack in the egg's shell) or, alternatively, a rotted, dead embryo. While an “early dead”, “mid-dead” or “late-dead egg” may be a rotted egg, those terms as used herein refer to such eggs which have not rotted. Clear, early-dead, mid-dead, late-dead, and rotted eggs may also be categorized collectively as “non-live” eggs because they do not include a living embryo.

Eggs which are to be hatched to live poultry are typically candled during embryonic development or later to identify non-live eggs and remove them from incubation to thereby increase available incubator space. U.S. Pat. Nos. 4,955,728 and 4,914,672, both to Hebrank, describe a candling apparatus that uses infrared detectors and the infrared radiation emitted from an egg to distinguish live from non-live eggs. U.S. Pat. No. 4,671,652 to van Asselt et al. describes a candling apparatus in which a plurality of light sources and corresponding light detectors are mounted in an array, and wherein eggs are passed on a flat between the light sources and the light detectors.

In many instances, it is desirable to introduce a substance, via in ovo injection, into a live egg prior to hatch. Injections of various substances into avian eggs are employed in the commercial poultry industry to decrease post-hatch mortality rates and/or increase growth rates of hatched birds. Similarly, the injection of virus into live eggs is utilized to propagate virus for use in vaccine preparation. Examples of substances that have been used for, or proposed for, in ovo injection include vaccines, antibiotics and vitamins. Examples of in ovo treatment substances and methods of in ovo injection are described in U.S. Pat. No. 4,458,630 to Sharma et al. and U.S. Pat. No. 5,028,421 to Fredericksen et al.

In ovo injections of substances typically occur by piercing the egg shell to create a hole through the egg shell (e.g., using a punch or drill), extending an injection needle through the hole and into the interior of the egg (and in some cases into the avian embryo contained therein), and injecting a substance through the needle. An example of an injection device designed to inject substances into avian eggs is disclosed in U.S. Pat. No. 4,681,063 to Hebrank. The Hebrank device positions an egg and an injection needle in a fixed relationship to each other, and is designed for the high-speed automated in ovo injection of a plurality of eggs. Alternatively, U.S. Pat. No. 4,458,630 to Sharma et al. describes a bottom (small end) injection machine.

In commercial poultry production, only about 60% to 90% of commercial broiler eggs hatch. Eggs that do not hatch include eggs that were not fertilized, as well as fertilized eggs that have died. Infertile eggs typically comprise from about 5% up to about 30% of all eggs set. Due to the number of non-live eggs encountered in commercial poultry production, the increasing use of automated methods for in ovo injection, and the cost of treatment substances, an automated method for identifying, in a plurality of eggs, those eggs that are suitable for injection and selectively injecting only those eggs identified as suitable, is desirable.

Conventionally, the candling and removal of non-live eggs from egg flats in a hatchery is performed at a different location from where in ovo injection of live eggs takes place. Because of the separate locations, it can be difficult to track egg flats after candling and accurately identify non-live eggs for removal and/or non-injection. As such, separate candling devices are often utilized in hatcheries, one for identifying eggs for removal and the other for identifying eggs to be injected. Unfortunately, the use of multiple candling devices may be costly and may add to the complexity of egg processing.

### SUMMARY OF THE INVENTION

In view of the above discussion, methods an apparatus for accurately and reliably detecting the presence of eggs within pockets of an egg flat, or other carrier, are provided. According to some embodiments of the present invention, an in ovo injection apparatus includes a plurality of injection devices configured to inject substances into a respective plurality of eggs held within respective pockets of an egg flat, and a sensor associated with each pocket of the egg flat that detects the presence of an egg therewithin. Each sensor generates a signal that indicates whether an egg is present or not within a respective pocket and communicates the signal, for example, to a respective injection device, and/or to a pump or other delivery device associated with a respective injection tool, and/or to a controller that communicates with a respective injection tool and/or respective pump/delivery device.

According to some embodiments of the present invention, an in ovo injection apparatus includes a plurality of injection devices configured to inject substances into a respective plurality of eggs held within respective pockets of an egg flat, and a sensor associated with each injection device that detects injection tool position, wherein injection tool position indicates whether an egg is present or not within a respective pocket. Each sensor generates a signal that indicates whether an egg is present or not within a respective pocket and communicates the signal, for example, to a respective injection device, and/or to a pump or other delivery device associated with a respective injection tool, and/or to a controller that communicates with a respective injection tool and/or respective pump/delivery device.

According to some embodiments of the present invention, a method of processing a plurality of eggs held within respective pockets of an egg flat includes sensing the presence of eggs within respective egg flat pockets via a plurality of sensors, generating and transmitting a signal that indicates whether an egg is present or not within each of the pockets, and processing eggs present within respective pockets. According to some embodiments of the present invention, processing eggs present within respective pockets comprises extracting material (e.g., allantoic fluid, amnion, yolk, shell, albumen, tissue, membrane and/or blood, etc.) from each egg. According to some embodiments of the present invention, processing eggs comprises injecting a substance (e.g., cells, vaccines, nucleic acids, proteins, peptides, and viruses, etc.) into the eggs.

According to some embodiments of the present invention, an egg processing apparatus includes one or more sensors configured to detect the presence of eggs within pockets of an egg flat moving relative thereto. The one or more sensors may include mechanical sensors, optical sensors, cameras, etc. The apparatus includes a plurality of injection devices configured to inject substances into the eggs within the egg flat (and/or remove material therefrom). The one or more sensors are configured to communicate whether an egg is present or not within a respective pocket to a respective injection device, and/or to a pump or other delivery device associated with a respective injection tool, and/or to a controller that communicates with a respective injection tool and/or respective pump/delivery device.

### BRIEF DESCRIPTION OF THE DRAWINGS

FIG. 1A is a perspective view of a conventional egg flat.

FIG. 1B is a top plan view of the egg flat of FIG. 1A.

FIG. 2 is a cross-sectional view of an egg supported within a pocket of the egg flat of FIG. 1A.

FIG. 3 is a flow chart of operations for detecting the presence of eggs within a carrier, according to some embodiments of the present invention.

FIG. 4 is a partial side section view of an in ovo injection apparatus having a plurality of sensors associated with the pockets of an egg flat and configured to detect the presence of eggs therewithin, according to some embodiments of the present invention.

FIG. 5 is a partial side section view of an in ovo injection apparatus having a plurality of sensors mounted on a tooling plate supporting the injection tools and that are configured to detect the presence of eggs within an egg flat, according to some embodiments of the present invention.

FIG. 6 is a partial cross-sectional view of the punch and needle portion of an injection tool, according to some embodiments of the present invention.

FIG. 7 is a partial side section view of an in ovo injection apparatus injection tool and upper and lower tooling plates, wherein an air passage is associated with the upper tooling plate for use in detecting the presence of an egg within an egg flat pocket, according to some embodiments of the present invention.

FIG. 8A is a side view of a mechanical “leaf” switch, according to some embodiments of the present invention, that is configured to detect the presence of eggs within an egg flat, and wherein the leaf switch is in a first position.

FIG. 8B is a side view of the mechanical leaf switch of FIG. 8A, wherein the leaf switch is in a second position.

FIG. 8C is a perspective view of a flat of eggs passing beneath a row of the leaf switches of FIGS. 8A-8B.

FIG. 9 is a perspective view of a flat of eggs passing beneath a row of cameras that are configured to detect the presence of eggs within the egg flat, according to some embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

As used herein, the terms “injection” and “injecting” encompass methods of inserting a device into an avian egg or embryo, including methods of delivering or discharging a substance into an egg or embryo, methods of removing a substance (i.e., a sample) from an egg or embryo, and/or methods of inserting a detector device into an egg or embryo.

Methods and apparatus according to embodiments of the present invention may be practiced with any type of avian egg, including, but not limited to, chicken, turkey, duck, geese, quail, ostrich, emu, squab, game hen, pheasant eggs, etc. An exemplary egg injection device, with which methods and apparatus for detecting the presence of eggs in an egg flat, according to embodiments of the present invention may be utilized, is the INOVOJECT® automated injection device (Embrex, Inc., Research Triangle Park, N.C.). However, embodiments of the present invention may be utilized with any in ovo processing device. Suitable injection devices preferably are designed to operate in conjunction with commercial egg carrier devices or flats.

Methods and apparatus according to embodiments of the present invention may be utilized to detect the presence of eggs in egg carriers when the eggs are in any of various orientations. Embodiments of the present invention are not limited only to the detection of eggs oriented in the illustrated orientation. Various types of egg carriers may be used in accordance with embodiments of the present invention. An exemplary egg carrier utilized in egg processing is an egg flat. As used herein, the terms “egg flat” and “egg carrier” are intended to be interchangeable.

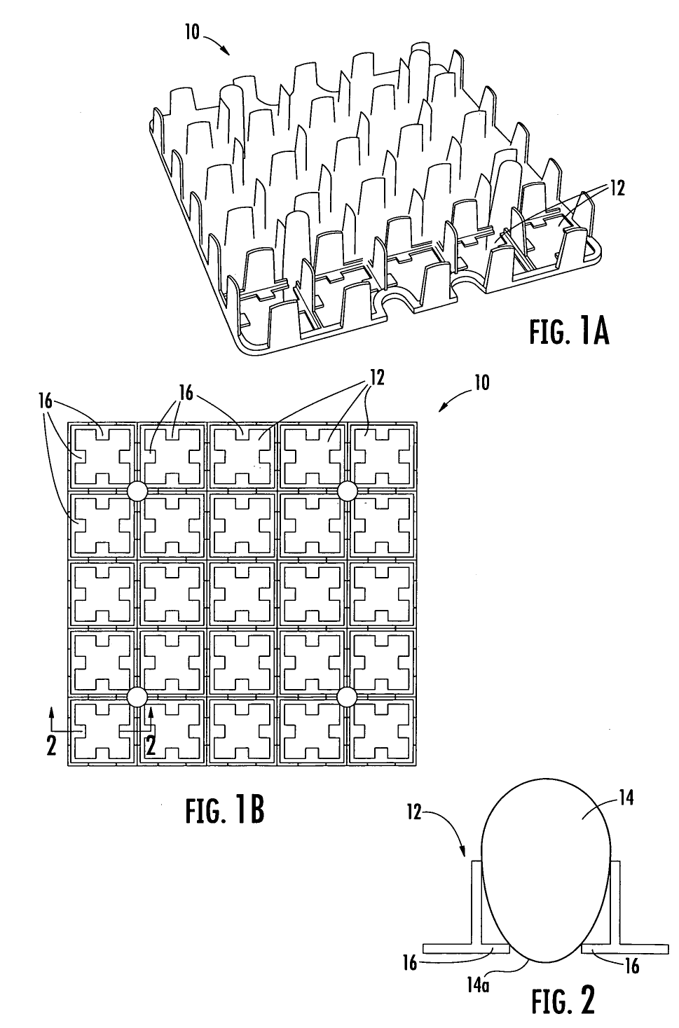

Egg flats contain an array of pockets that are configured to support a respective plurality of eggs, conventionally in a generally upright orientation. An exemplary egg flat 10 is illustrated in FIGS. 1A-1B. The illustrated egg flat 10 includes a plurality of rows of pockets 12. Each pocket 12 is configured to receive one end 14a of a respective egg 14 so as to support the respective egg 14 in a substantially vertical position. Each pocket 12 of the illustrated egg flat 10 contains a plurality of tabs 16 (FIG. 1B) that are configured to support a respective egg as illustrated in FIG. 2.

Egg flats of virtually any type may be used in accordance with embodiments of the present invention. Flats may contain any number of rows, such as seven rows, with rows of six and seven being most common. Moreover, eggs in adjacent rows may be parallel to one another, as in a “rectangular” flat, or may be in a staggered relationship, as in an “offset” flat. Examples of suitable commercial flats include, but are not limited to, the “CHICKMASTER 54” flat, the “JAMESWAY 36” flat, the “JAMESWAY 42” flat and the “JAMESWAY 84” flat (in each case, the number indicates the number of eggs carried by the flat). Egg flats are well known to those of skill in the art and need not be described further herein.

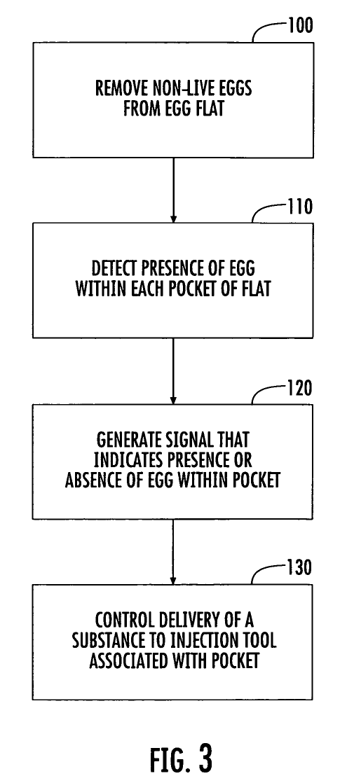

Referring to FIG. 3, methods for selectively processing eggs (e.g., injecting substance into eggs and/or removing substances from eggs) held within egg flats, according to embodiments of the present invention, are illustrated. Initially, non-live eggs are removed from an egg flat (Block 100). Non-live egg removal may include identifying non-live eggs via candling, heartbeat detection, and/or other techniques or combination of techniques. Non-live eggs may be removed either automatically or by hand. Removed eggs may be discarded or may be subjected to additional processing for various purposes.

Subsequent to the removal of any non-live eggs from the flat, the presence of an egg within each pocket of a flat is then automatically detected via a respective sensor associated with each respective pocket (Block 110) and a signal that indicates whether an egg is present or not within the pocket is generated (Block 120). A sensor, according to embodiments of the present invention, may be any type of device capable of detecting the presence of an egg within a pocket and sending a signal that indicates the presence or absence of an egg. Exemplary sensors include, but are not limited to, light sensors, pressure sensors, contact switches, etc.

Still referring to FIG. 3, in response to receiving a signal from a sensor, the delivery of a substance to an injection tool associated with the pocket is controlled (Block 130). For example, if an egg is not present within a pocket, a signal that indicates the absence of an egg is transmitted to an injection tool associated with the pocket and the injection tool does not inject a substance. If an egg is present within a pocket, a signal that indicates the presence of an egg is transmitted to an injection tool associated with the pocket and the injection tool injects the egg with a substance(s) (and/or removes a substance(s) from the egg).

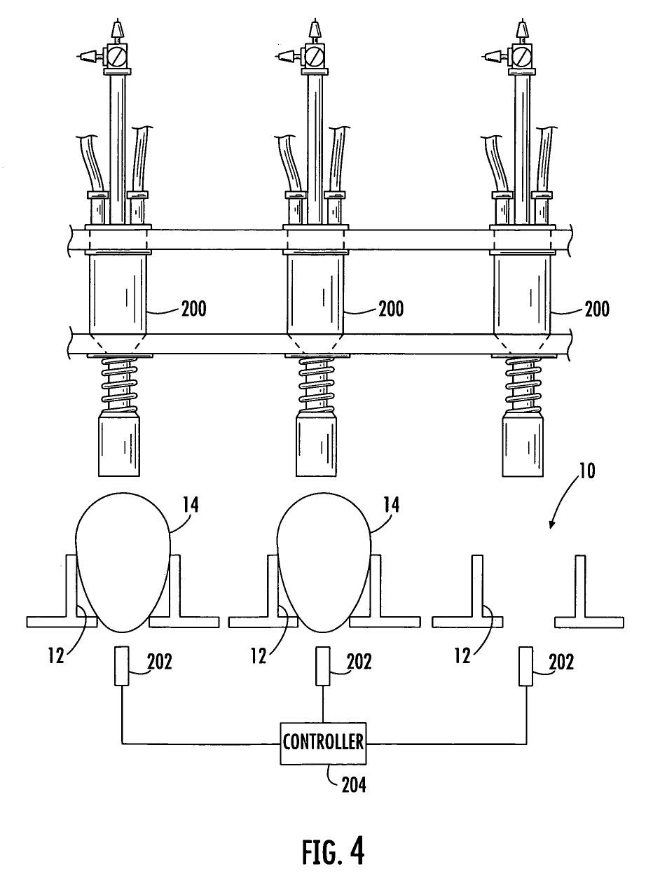

Referring to FIG. 4, a portion of an in ovo injection apparatus, according to some embodiments of the present invention, is illustrated with a plurality of injection devices 200 configured to inject one or more substances (e.g., fluids) into a respective plurality of eggs held within respective pockets 12 of an egg flat 10. Each injection device 200 is configured to deliver a predetermined dosage of fluid from a fluid source into an egg.

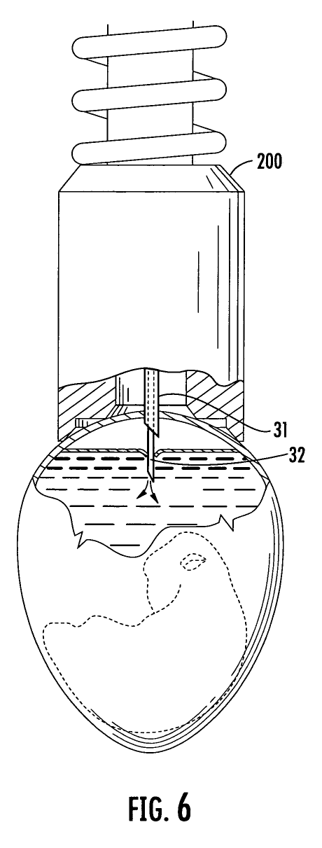

According to some embodiments of the present invention, each injection tool includes a punch configured to form an opening in the shell of an egg, as illustrated, for example, in FIG. 6. An injection needle 32 is movably disposed within a punch 31 (i.e., the punch 31 substantially concentrically surrounds the respective needle 32) so that after the punch 31 makes an opening in the shell of an egg, the injection needle 32 can move through the punch 31 and respective opening of an egg shell to an injecting position within an egg for delivery of a substance(s) therein (and/or removal of material therefrom). See, for example, U.S. Pat. No. RE35,973. However, various types of injection tools may be utilized in accordance with embodiments of the present invention.

A sensor 202 is associated with each pocket 12 of the egg flat 10 and is configured to detect the presence of an egg therewithin. According to some embodiments of the present invention, each sensor 202 is a reflective photosensor. However, various other types of sensors may be utilized without limitation. Other types of sensors 202 that may be utilized include, but are not limited to, transmission photo sensors, cameras, etc. According to some embodiments of the present invention, each sensor 202 may operate in conjunction with a light source located on a respective injection tool 200.

Each sensor 202 generates a signal that indicates whether an egg is present or not within a respective pocket 12 and transmits the signal to the injection devices 200 via a controller 204 that communicates with the injection devices 200. In response to receiving a signal that an egg is not present within a pocket 12, the respective injection tool for that pocket does not inject a substance, or does not receive a substance for injection from a substance delivery system, etc. In response to receiving a signal that an egg is present within a pocket 12, the injection tool proceeds with injecting a substance into the egg (and/or removing a sample of material from the egg).

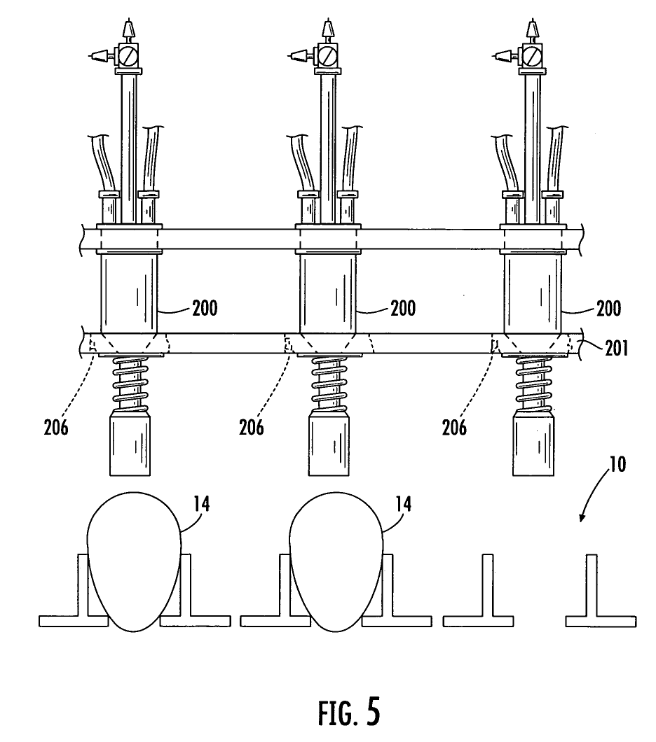

According to some embodiments of the present invention, devices 206 for sensing the presence of eggs in respective egg flat pockets may be mounted on a tooling plate 201 supporting the injection tools 200, as illustrated in FIG. 5. Alternatively, devices 206 for sensing the presence of eggs in respective egg flat pockets may be mounted directly on the injection tools 200. When an injection tool 200 contacts an egg 14 in a flat pocket, the injection tool 200 disengages from the tooling plate and is free to adjust itself vertically to the height and tilt of the egg by virtue of the disengagement of the tooling plate 201. If no egg is present in a flat pocket, contact is not made with an egg by a respective injection tool 200 and the injection tool 200 does not disengage from the tooling plate 201, but continues to follow the tooling plate 201 downwardly. When an egg is present within a pocket, the injection tool 200 contacts the egg, disengages from the tooling plate 201 and stops following the downward movement of the tooling plate 201.

Each device 206 is configured to sense the position of a respective injection tool 200 relative to the tooling plate 201. According to some embodiments of the present invention, each device 206 may be a mechanical, optical, pneumatic or inductive sensor. For example, each device may be an inductive proximity sensor or magnetic sensor that energizes and checks for injection tool position upon, for example, a radio command to the device 206. Each device 206 may be a mechanical switch that activates upon detected movement of an injection tool 200 relative to the tooling plate 201.

Each device 206 then transmits measured injection tool position back to a controller that controls operation of the injector tools 200. In response to receiving a signal that an egg is not present within a pocket 12, the respective injection tool for that pocket does not inject a substance. In response to receiving a signal that an egg is present within a pocket 12, the respective injection tool for that pocket proceeds with injecting a substance into the egg.

According to some embodiments of the present invention, each device 206 may be controlled via low-power electronics and a low power communication standard, such as Zigbee. As known to those skilled in the art, Zigbee is a specification set of high level communication protocols designed to use small, low power digital radios based on the IEEE 802.15.4 standard for wireless personal area networks (WPANs). According to some embodiments of the present invention, each device 206 may be powered by one or more batteries, by one or more rechargeable batteries, by photovoltaics, etc., thereby eliminating the need for wires connecting to each device 206 and simplifying wiring and enhancing water resistance of the device 206.

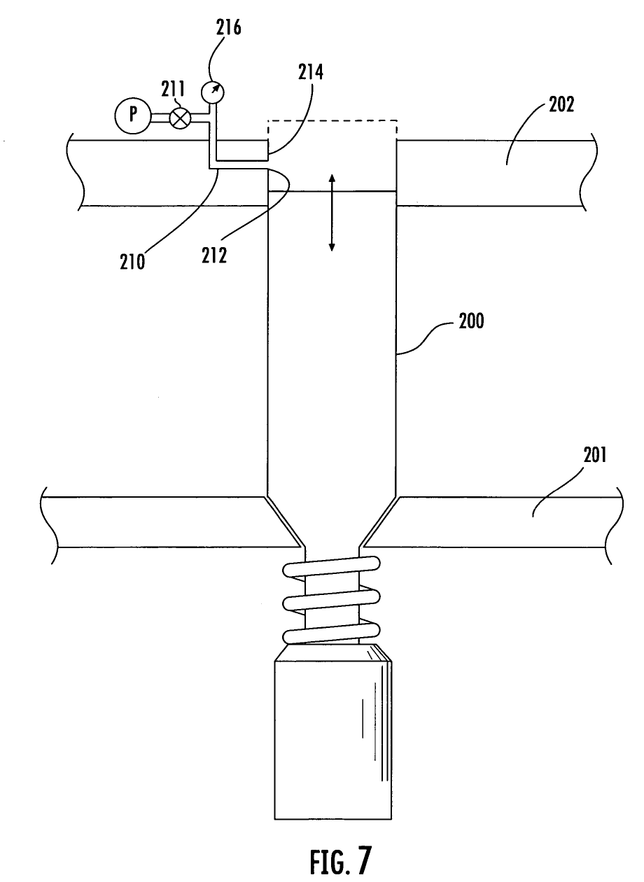

Other methods of sensing the presence of eggs in egg flat pockets may be accomplished by detecting injection tool movement. For, example, referring to FIG. 7, an upper tooling plate 202 of an in ovo injection apparatus includes an air passage 210 that terminates at a port 212 in the wall 214 of the tooling plate 202 that defines a tooling plate aperture 214 through which an injection tool 200 is configured to reciprocally move. The air passage 210 is connected to a pressurized air (or other gas) source P via a restriction (e.g., a valve) 211, which provides the air passage 210 with pressurized air (or other gas, such as an inert gas, etc.). If the body of the injection tool blocks the air passage port 212, pressure within the air passage has a first pressure (e.g., 18 psi). If the injection tool 200 moves so as to uncover the air passage port 212, air pressure within the passage 210 drops to a second pressure (e.g., 5 psi). The first and second pressures may be virtually any pressure. Embodiments of the present invention are not limited to any particular pressures for the first and second pressures.

Moreover, embodiments of the present invention are not limited to the illustrated air passage 210 configuration. Air passages may be arranged in various configurations relative to injection tools in accordance with the spirit and intent of the present invention. For example, according to other embodiments of the present invention, each injection tool may be configured with a separate air passage that activates a pneumatic switch based on injection tool movement and position.

Still referring to FIG. 7, the injection tool 200 and the upper and lower tooling plates 202, 201 move downwardly towards an egg flat in unison prior to injecting eggs in ovo, as would be understood by one skilled in the art of the present invention. If an egg is present within an egg flat pocket beneath the injection tool 200, the injection tool 200 will contact the egg and this will cause the injection tool to stop its downward movement as the tooling plates 201, 202 continue to move downwardly. Thus, if an egg is present within an egg flat pocket, the body of the injection tool 200 will not uncover the air passageway port 212, and the pressure within the air passage 210 will remain at the first level. If an egg is not present within the egg flat pocket, the injection tool 200 will continue downwardly with the tooling plates 210, 202 and the air passage port 212 will become uncovered. As a result of the port 212 becoming uncovered, pressure within the air passage 210 decreases to a second level. This decrease in pressure is an indication that no egg is present within the respective egg flat pocket.

According to some embodiments of the present invention, a pressure sensor 216 transmits signals to a controller (not illustrated) that controls operation of the injector tools 200, as would be understood by one skilled in the art of the present invention. In response to receiving a signal that an egg is not present within a pocket, the respective injection tool for that pocket does not inject a substance (and/or remove a sample of material from the missing egg). In response to receiving a signal that an egg is present within a pocket, the respective injection tool for that pocket proceeds with injecting a substance into the egg (and/or removing a sample of material from the egg).

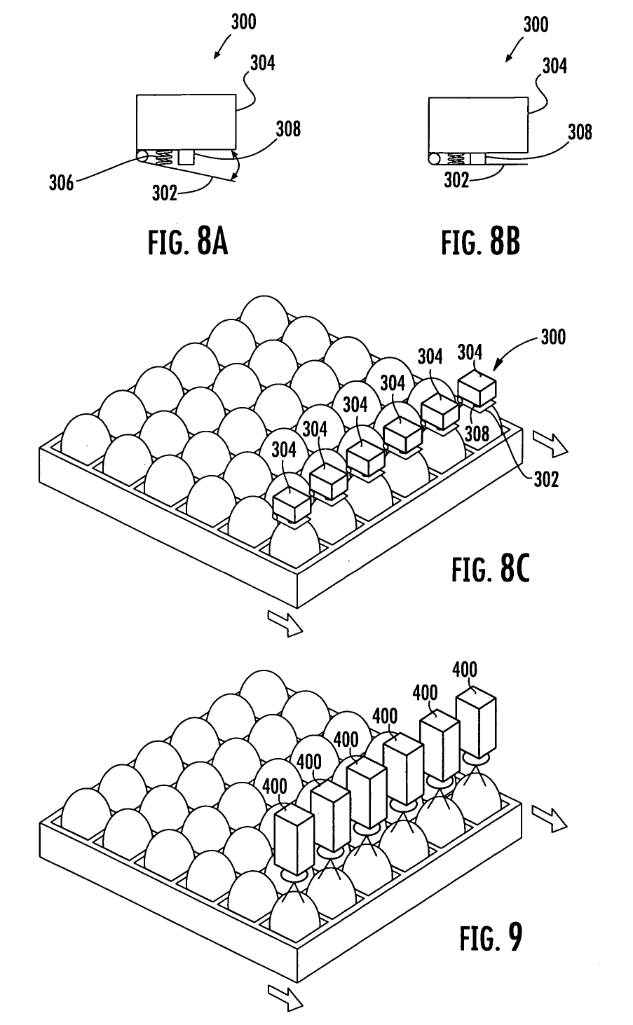

According to some embodiments of the present invention, a series of mechanical switches may be utilized to detect the presence of eggs within an egg flat. For example, as illustrated in FIG. 8A, a mechanical switch 300, sometimes referred to as a “leaf switch”, may be utilized. The illustrated leaf switch 300 includes an arm 302 pivotally secured to the body 304 of the switch. A spring 306 is provided to urge the arm 302 to first position, as illustrated in FIG. 8A. Spring 306 may be any type of spring and may have various configurations, without limitation. When arm 302 makes contact with an egg, the arm 302 is moved to a second position (FIG. 8B) such that the arm 302 touches a contact 308. This causes a signal to be generated that indicates an egg is present within a particular egg flat pocket. When no egg is present within a particular egg flat pocket, arm 302 does not touch contact 308.

Contact 308 may be an electrical contact that closes a circuit when arm 302 makes contact therewith. Alternatively, contact 302 may be an actuator button that closes a circuit when arm 302 makes contact therewith so as to cause movement of the actuator button, as would be understood by one skilled in the art of the present invention.

The present invention is not limited to mechanical switches having the illustrated embodiment of switch 300. Mechanical-type switches having various configurations and modes of operation may be utilized without limitation.

FIG. 8C illustrates a flat of eggs passing beneath a row of the switches 300 of FIGS. 8A-8B. The switches 300 are configured to transmit signals to a controller (not illustrated) that controls operation of the injector tools of an in ovo injection apparatus. In response to receiving a signal that an egg is not present within a pocket, the respective injection tool for that pocket does not inject a substance (and/or remove a sample of material from the missing egg). In response to receiving a signal that an egg is present within a pocket, the respective injection tool for that pocket proceeds with injecting a substance into the egg (and/or removing a sample of material from the egg).

According to some embodiments of the present invention, one or more cameras may be utilized to detect the presence of eggs within egg flat pockets as a flat of eggs enters an in ovo injection apparatus. The one or more cameras generate a signal that indicates whether an egg is present or not within a respective pocket and transmits the signal to the injection devices via a controller that communicates with the injection devices. In response to receiving a signal that an egg is not present within a pocket, the respective injection tool for that pocket does not inject a substance, or does not receive a substance for injection from a substance delivery system, etc., as described above. In response to receiving a signal that an egg is present within a pocket, the injection tool proceeds with injecting a substance into the egg (and/or removing a sample of material from the egg), as described above.

FIG. 9 is a perspective view of a flat of eggs passing beneath a row of cameras 400 that are configured to detect the presence of eggs within the egg flat, according to some embodiments of the present invention. The cameras 400 are configured to transmit signals to a controller (not illustrated) that controls operation of the injector tools of an in ovo injection apparatus. In response to receiving a signal that an egg is not present within a pocket, the respective injection tool for that pocket does not inject a substance (and/or remove a sample of material from the missing egg). In response to receiving a signal that an egg is present within a pocket, the respective injection tool for that pocket proceeds with injecting a substance into the egg (and/or removing a sample of material from the egg).

Although illustrated as a single camera per pocket in FIG. 9, embodiments of the present invention may utilize a single camera for more than one pocket. For example, a single camera may be configured to detect the presence of eggs in multiple pockets, even all pockets in an entire egg flat.

Sensors for detecting the presence of eggs within egg flats, according to embodiments of the present invention, may communicate with in ovo injection tools in various ways. For example, according to some embodiments of the present invention, sensors may communicate via electrical signals that activate an electrical pump or other delivery device associated with each injection tool. According to some embodiments of the present invention, sensors may communicate via RF wireless signals that activate a pump or other delivery device associated with injection tools.

According to some embodiments of the present invention, sensors may communicate via a mechanical linkage (e.g., a string, filament, wire, rod, member, etc.) that activates an electrical pump or other delivery device associated with each injection tool. According to some embodiments of the present invention, sensors may communicate via a pressure or air flow signal that activates a pump, valve or other delivery device associated with each injection tool.

According to some embodiments of the present invention, the signal from each sensor may directly activate a substance pump or other delivery device, or may activate some other part of a pumping system (e.g., a pinch valve) associated with the injection tools of an in ovo injection apparatus. According to some embodiments of the present invention, the signals from the sensors may be received by a computer or controller used to control a substance pumping system.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An in ovo injection apparatus, comprising:
a plurality of injection devices configured to inject substances into a respective plurality of eggs held within respective pockets of an egg flat; and
a sensor associated with each pocket of the egg flat that detects the presence of an egg therewithin, wherein each sensor generates a signal that indicates whether an egg is present or not within a respective pocket.

2. The apparatus of claim 1, wherein each sensor communicates a generated signal that indicates whether an egg is present or not within a respective pocket to a respective injection device.

3. The apparatus of claim 1, wherein each sensor communicates a generated signal that indicates whether an egg is present or not within a respective pocket to a substance delivery system associated with a respective injection device.

4. The apparatus of claim 1, wherein each injection device comprises:
a tubular punch for forming an opening in the shell of an egg; and
an injection needle positioned within the tubular punch for movement therethrough and through an opening in an egg shell formed by the tubular punch for delivery of a substance into an egg.

5. The apparatus of claim 1, wherein each sensor comprises an optical sensor.

6. The apparatus of claim 1, wherein each sensor comprises a camera.

7. The apparatus of claim 1, wherein each sensor comprises a mechanical sensor.

8. The apparatus of claim 3, wherein each sensor communicates a generated signal to the substance delivery system electrically.

9. The apparatus of claim 3, wherein each sensor communicates a generated signal to the substance delivery system wirelessly.

10. The apparatus of claim 3, wherein each sensor communicates a generated signal to the substance delivery system mechanically.

11. The apparatus of claim 3, wherein each sensor communicates a generated signal to the substance delivery system pneumatically.

12. An in ovo injection apparatus, comprising:
a plurality of injection devices configured to inject substances into a respective plurality of eggs held within respective pockets of an egg flat; and
a sensor associated with each injection device that detects injection tool position, wherein injection tool position indicates whether an egg is present or not within a respective pocket, wherein each sensor generates a signal that indicates whether an egg is present or not within a respective pocket.

13. The apparatus of claim 12, wherein each sensor communicates a generated signal that indicates whether an egg is present or not within a respective pocket to a respective injection device.

14. The apparatus of claim 12, wherein each sensor communicates a generated signal that indicates whether an egg is present or not within a respective pocket to a substance delivery system associated with a respective injection device.

15. The apparatus of claim 12, wherein each injection device comprises:
a tubular punch for forming an opening in the shell of an egg; and
an injection needle positioned within the tubular punch for movement therethrough and through an opening in an egg shell formed by the tubular punch for delivery of a substance into an egg.

16. The apparatus of claim 12, wherein each sensor comprises an optical sensor.

17. The apparatus of claim 12, wherein each sensor comprises a camera.

18. The apparatus of claim 12, wherein each sensor comprises a mechanical sensor.

19. The apparatus of claim 12, wherein each sensor comprises a pneumatic sensor.

20. The apparatus of claim 12, wherein each sensor comprises an inductive proximity sensor.

21. The apparatus of claim 14, wherein each sensor communicates a generated signal to the substance delivery system electrically.

22. The apparatus of claim 14, wherein each sensor communicates a generated signal to the substance delivery system wirelessly.

23. The apparatus of claim 14, wherein each sensor communicates a generated signal to the substance delivery system mechanically.

24. The apparatus of claim 14, wherein each sensor communicates a generated signal to the substance delivery system pneumatically.

25. The apparatus of claim 12, wherein each sensor comprises a passageway formed within a tooling plate associated with the injection devices, wherein the passageway contains pressurized gas, and wherein injection tool position is detected by changes in pressure within the passageway.

26. A method of processing a plurality of eggs held within respective pockets of an egg carrier, the method comprising:
sensing the presence of eggs within respective pockets of an egg carrier via a plurality of sensors;
generating and transmitting a signal for each egg present within a respective pocket; and
processing eggs present within the respective pockets in response to receiving the respective signals.

27. The method of claim 26, wherein processing eggs present within respective pockets comprises extracting material from each egg.

28. The method of claim 27, wherein extracting material from each egg comprises extracting allantoic fluid, amnion, yolk, shell, albumen, tissue, membrane and/or blood.

29. The method of claim 26, wherein processing eggs comprises injecting a substance into the eggs.

30. The method of claim 29, wherein injecting a substance into the eggs comprises:
forming an opening within a portion of the shell of each egg;
extending a respective injection tool through the opening and into the egg.

31. The method of claim 29, wherein the substance is selected from the group consisting of cells, vaccines, nucleic acids, proteins, peptides, and viruses.

32. An egg processing apparatus comprising one or more sensors configured to detect the presence of eggs within pockets of an egg carrier moving relative thereto.

33. The apparatus of claim 32, wherein the one or more sensors comprises one or more mechanical switches.

34. The apparatus of claim 32, wherein the one or more sensors comprises one or more cameras.

35. The apparatus of claim 32, further comprising a plurality of injection devices configured to inject substances into the eggs within the egg carrier, and wherein the sensors are configured to generate a signal that indicates whether an egg is present or not within a respective pocket.

36. The apparatus of claim 35, wherein each injection device comprises:
a tubular punch for forming an opening in the shell of an egg; and
an injection needle positioned within the tubular punch for movement therethrough and through an opening in an egg shell formed by the tubular punch for delivery of a substance into an egg.
